(19) United States
(12) Patent Application Publication
(10) Pub. No.: US 2021/0034389 A1
(43) Pub. Date: Feb. 4, 2021

(54) DESKTOP VIRTUALIZATION WITH LINKED POWER MANAGEMENT TO CLIENT DEVICES

(71) Applicant: CITRIX SYSTEMS, INC., Fort Lauderdale, FL (US)

(72) Inventor: Juan C. Rivera, Fort Lauderdale, FL (US)

(21) Appl. No.: 16/524,365

(22) Filed: Jul. 29, 2019

(51) Int. Cl. G06F 9/455; G06F 9/4401; G06F 1/26

(52) U.S. Cl. CPC G06F 9/45558; H04L 67/42; G06F 1/26; G06F 9/4401

(57) ABSTRACT

A computer system includes a client device that includes a physical power control input to change the client device between on/off states, and a virtual server running virtual machines, with the client device accessing one of the virtual machines. The computer system includes a computing platform that interfaces with the client device and the virtual server to map the client device to the virtual machine being accessed by the client device, and receive at least one power control signal from the client device based on selection of the physical power control input. The computing platform initiates, in response to the received at least one power control signal and the client device being mapped to the virtual machine, a change in an on/off state of the virtual machine to match a change in the on/off state of the client device so as to reboot the virtual machine.

### TECHNICAL FIELD

The present disclosure relates to desktop virtualization, and more particularly, to power management of virtual desktops.

### BACKGROUND

There are several different types of desktop virtualization systems. As an example, Virtual Desktop Infrastructure (VDI) refers to the process of running a user desktop inside a virtual machine that resides on a server, with the virtual machine providing a virtual computing session. Servers in such systems may include storage for virtual desktop images and system configuration information, as well as software components to provide the virtual desktops and allow users to interconnect to them. For example, a VDI server may include one or more hypervisors (i.e., virtual machine managers) to create and maintain multiple virtual machines, software to manage the hypervisors, a connection broker, and software to provision and manage the virtual desktops.

Desktop virtualization systems may be implemented using a single virtualization server or a combination of servers interconnected as a server grid. For example, a cloud computing environment, or cloud system, may include a pool of computing resources (e.g., desktop virtualization servers), storage disks, networking hardware, and other physical resources that may be used to provision virtual desktops, along with additional computing devices to provide management and customer portals for the cloud system.

### SUMMARY

A computer system includes a client device that including a physical power control input to change the client device between on/off states, and a virtual server to run a plurality of virtual machines, with the client device accessing one of the virtual machines. The computer system further includes a computing platform interfacing with the client device and the virtual server. The computing platform maps the client device to the virtual machine being accessed by the client device, receive at least one power control signal from the client device based on selection of the physical power control input, and initiate, in response to the received at least one power control signal and the client device being mapped to the virtual machine, a change in an on/off state of the virtual machine to match a change in the on/off state of the client device so as to reboot the virtual machine.

The received at least one power control signal may include first and second power control signals, and wherein the virtual machine changes from an on-state to an off-state based on the first power control signal, and back to the on-state based on the second power control signal so that the virtual machine reboots along with the client device.

The physical power control input may comprise a push button, with the push button being pressed for a set duration so that the at least one power control signal is a single power control signal, and wherein the virtual machine changes from an on-state to an off-state and back to the on-state based on the single power control signal so that the virtual machine reboots along with the client device.

The computing platform may notify the client device when the virtual machine changes on/off states to ensure that the client device and the virtual machine have the same on/off state.

The computing platform may comprise an endpoint management server and a broker server. The endpoint management server may register the client device before performing the mapping, and receive the at least one power control signal from the client device. The broker server may receive the at least one power control signal from the endpoint management server, and initiate the change in the on/off state of the virtual machine.

The plurality of virtual machines provide a plurality of virtual computing sessions, with the client device accessing one of the virtual computing sessions. The virtual server may further comprise at least one hypervisor configured to manage the plurality of virtual machines, and to change the on/off state of the virtual machine providing the virtual computing session to the client device in response to the received at least one power control signal and the client device being mapped to the virtual machine.

The computing platform may be cloud-based. The client device may be configured as a thin client device.

Another aspect is directed to a computing platform comprising at least one memory and at least one processor cooperating with the at least one memory. The at least one processor may be configured to map a client device to a virtual machine being accessed by the client device, and with the client device including a physical power control input to change the client device between on/off states. The at least one processor may receive at least one power control signal from the client device based on selection of the physical power control input, and initiate, in response to the received at least one power control signal and the client device being mapped to the virtual machine, a change in an on/off state of the virtual machine to match a change in the on/off state of the client device so as to reboot the virtual machine.

Yet another aspect is directed to a method for operating a computing platform comprising mapping a client device to a virtual machine being accessed by the client device, and with the client device including a physical power control input to change the client device between on/off states, and receiving at least one power control signal from the client device based on selection of the physical power control input. The method may further comprise initiating, in response to the received at least one power control signal and the client device being mapped to the virtual machine, a change in an on/off state of the virtual machine to match a change in the on/off state of the client device so as to reboot the virtual machine.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computer system providing desktop virtualization to a client device with linked power management to a virtual machine in which various aspects of the disclosure may be implemented.

FIG. 7 is a flowchart illustrating a method for operating the computer system illustrated in FIG. 6.

FIG. 8 is a flowchart illustrating a method for operating the cloud computing service illustrated in FIG. 6.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout.

As will be discussed below, organizations or enterprises are replacing physical desktops with client devices that access virtual desktops running on virtual servers. The transition for some users from their physical desktops to desktop virtualization is smoother the closer to a local experience users get as if they are still using their physical desktops.

For example, when replacing a physical desktop with a client device that accesses a virtual desktop, one of the challenges is the ability to reboot the virtual machine running the virtual desktop. To reboot a physical desktop, it is intuitive for a user to select a power control input on the physical desktop so that it turns off and turns back on again.

A reboot is necessary when the operating system or a hardware driver has stopped working. For example, a graphics driver may crash causing the operating system to be frozen. Another example is software code that may be stuck in a misbehaving state. A reboot will bring the physical desktop up from scratch, restarting all the software so it will work just as well as it was working before.

However, it is not intuitive for the user to reboot their virtual desktop. With desktop virtualization, if the user selects the power control input on the client device so that it turns off and turns back on again, only the client device is rebooted. To reboot the virtual machine running the virtual desktop, the user needs to select reset from a virtual desktop menu or toolbar. Many times users are not aware of this option and simply contact an information technology (IT) administrator to perform the reboot. In fact, one of the most common requests from users to IT administrators is to reboot their virtual desktops.

To solve the problems with existing virtualization technologies described above, the present disclosure describes systems, devices and methods in which the action of rebooting the client device is linked to the virtual desktop. This creates an illusion to the user that the client device and virtual desktop are one and the same. To perform a reboot of the virtual desktop, the user selects a physical power control input on the client device to change on/off states, then a corresponding power management control is provided to the virtual server so that the virtual machine providing the virtual desktop changes to the same on/off state as the client device.

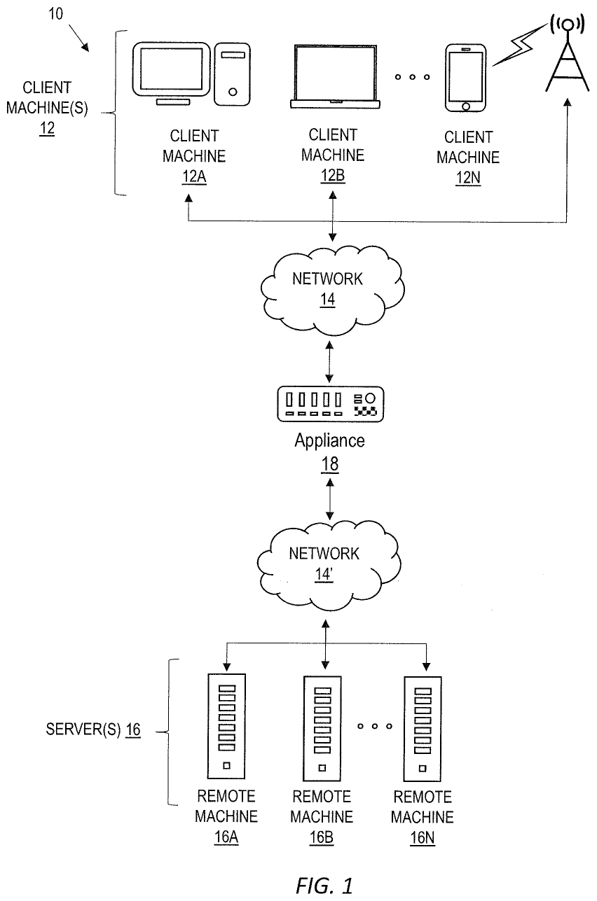

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′.

In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 108 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

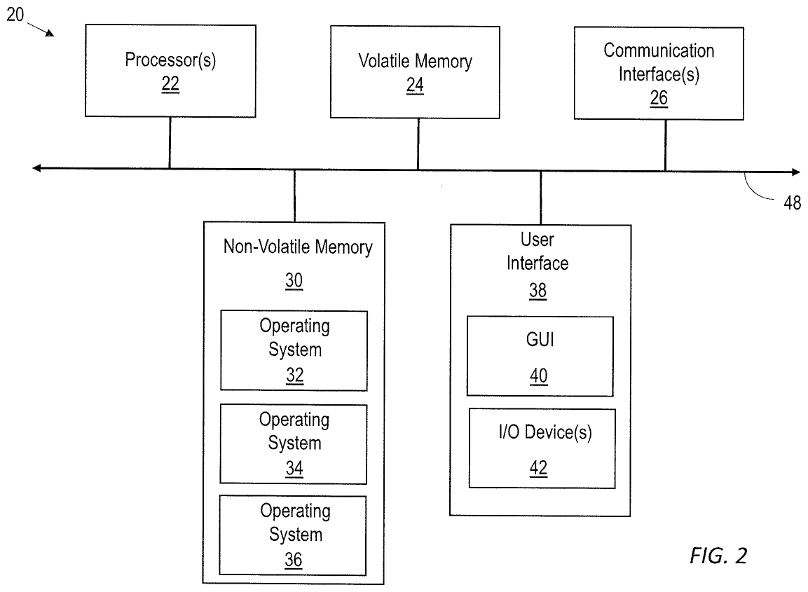

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Fla. (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

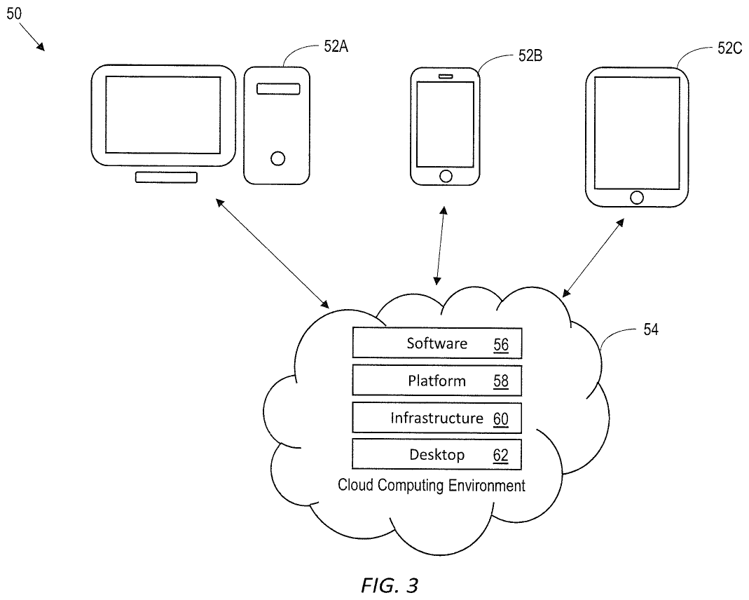

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOGGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

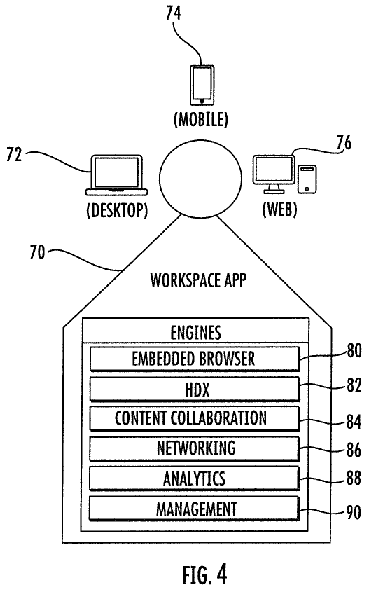

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, i0S, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific μ-VPN connection. A μ-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing counter-measures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

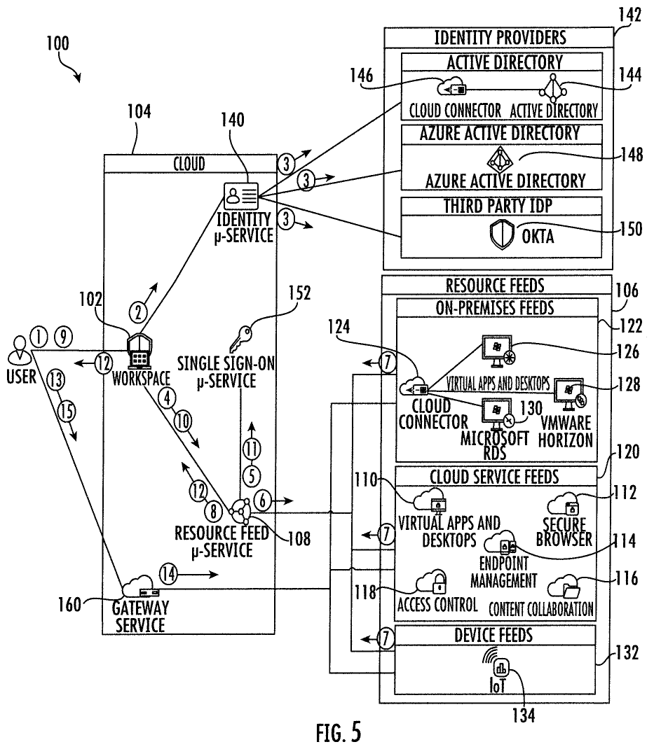

Referring now to FIG. 5, a workspace network environment 100 providing a unified experience to a user based on the workspace app 70 will be discussed. The desktop, mobile and web versions of the workspace app 70 all communicate with the workspace experience service 102 running within the Citrix Cloud 104. The workspace experience service 102 then pulls in all the different resource feeds 16 via a resource feed micro-service 108. That is, all the different resources from other services running in the Citrix Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Citrix Cloud 104, and presenting their identity (event 1). The identity includes a user name and password, for example.

The workspace experience service 102 forwards the user's identity to an identity micro-service 140 within the Citrix Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Citrix Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

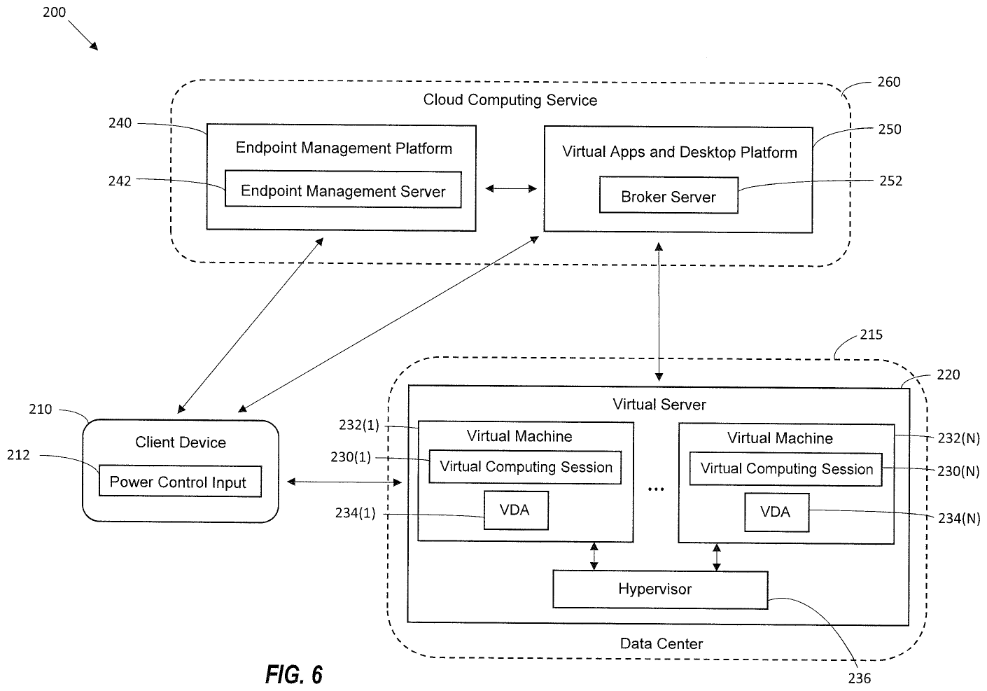

Referring now to FIG. 6, one of the challenges in replacing physical desktops with desktop virtualization is the ability to reboot a virtual machine 232(1) providing a virtual computing session 230(1) to a client device 210. For example, a reboot is necessary when the operating system or a hardware driver has stopped working. A graphics driver may crash causing the operating system to be frozen, or a software code may be stuck in a misbehaving state. A reboot will bring the virtual machine 232(1) up from scratch, restarting all the software so it will work just as well as it was working before.

For users transitioning from physical desktops to a client device 210 accessing one of the virtual machines 232(1), it may not be intuitive for the users to select reset from a virtual desktop menu or toolbar. By linking power management control from the client device 210 to the virtual machine 232(1) via a cloud computing service 260, the virtual machine 232(1) is rebooted at the same time the client device 210 is rebooted.

The transition for users from their physical desktops to desktop virtualization is smoother the closer to a local experience users get as if they are still using their physical desktops. In this case, a power control input 212 on the client device 210 is linked to the virtual machine 232(1). This advantageously creates an illusion to the user that the client device 210 and the virtual machine 232(1) are one and the same.

The client device 210 may be a smartphone, a tablet computer, a laptop computer, a desktop computer, for example. In addition, the client device 210 may be a thin client. A thin client is very compact since it is based on a single-board computer, as provided by Raspberry Pi, for example. The single-board computer is typically a system on a chip (SoC) with an integrated Advanced RISC Machines (ARM)-compatible central processing unit (CPU) and an on-chip graphics processing unit (GPU). Thin clients are attractive for large enterprises and organizations because of their low costs.

The illustrated computer system 200 includes a client device 210, a virtual server 220, and a cloud computing service 260 interfacing with the client device 210 and the virtual server 220. The virtual server 220 may also be referred to as a server, and the cloud computing service 260 may also be referred to as a computing platform or a computing device. To simplify the computer system 200, only one client device 210 and one virtual server 220 are shown. However, additional client devices 210 and virtual servers 220 may be provided as necessary.

The client device 210 includes a physical power control input 212 to change the client device 210 between on/off states. The physical power control input 212 may be a push button or a toggle switch, for example. The virtual server 220 is configured to run a plurality of virtual machines 232(1)-232(N) providing a plurality of virtual computing sessions 230(1)-230(N), with the client device 210 accessing one of the virtual machines 230(1). The virtual machines 232(1)-232(N) may be generally referred to as virtual machines 232. The virtual computing sessions 230(1)-230(N) may be generally referred to as virtual computing sessions 230.

The cloud computing service 260 is configured to map the client device 210 to the virtual machine 232(1) being accessed by the client device 210, and to receive at least one power control signal from the client device 210 based on selection of the physical power control input 212. Power management control is thus provided by the cloud computing service 260 to the virtual server 220. The cloud computing service 260 initiates, in response to the received at least one power control signal and the client device 210 being mapped to the virtual machine 232(1), a change in an on/off state of the virtual machine 232(1) to match a change in the on/off state of the client device 210 so as to reboot the virtual machine 232(1).

The received at least one power control signal may include first and second power control signals. This is based on the physical power control input 212 being placed in an off state and then back to an on state. As a result, the virtual machine 232(1) changes from an on-state to an off-state based on the first power control signal, and back to the on-state based on the second power control signal so that the virtual machine 232(1) reboots along with the client device 210. A state of the virtual machine 232(1) is mapped to a state of the client device 210.

As noted above, the physical power control input 210 may a push button. To initiate a reboot of the virtual machine 232(1), the push button is pressed for a set duration during selection. The set duration may be several seconds or more, for example. This results in the at least one power control signal being a single power control signal, and wherein the virtual machine 232(1) changes from an on-state to an off-state and back to the on-state based on the single power control signal so that the virtual machine 232(1) reboots along with the client device 210. Again, a state of the virtual machine 232(1) is mapped to a state of the client device 210.

The cloud computing service 260 notifies the client device 210 when the virtual machine 232(1) changes on/off states to ensure that the client device 210 and the virtual machine 232(1) have the same on/off state. Power control of the virtual machine 232(1) is mapped to the client device 210 so that when the client device 210 changes on/off states then the virtual machine 232(1) also changes to the same on/off state. Likewise, if the client device 210 is rebooted, then the virtual machine 232(1) is rebooted.

The cloud computing service 260 provides a virtual desktop infrastructure (VDI) in which virtual computing sessions 230 are typically delivered as a cloud service. The cloud computing service 260 may also be referred to as a computing platform or computing device. In particular, the cloud computing service 260 includes an endpoint management platform 240 that includes an endpoint management server 242, and a virtual apps and desktop platform 250 that includes a broker server 252.

The endpoint management platform 240 manages client devices 210, which are referred to as endpoints. One example architecture for managing client devices 210 is Citrix Endpoint Management (CEM) provided by Citrix Systems, Inc. When the user logs into the client device 210, the client device 210 registers with an endpoint management server 242. The endpoint management server 242 includes at least one processor and at least one memory cooperating therewith. Once the client device 210 is registered, the endpoint management server 242 configures the client device 210 and implements policies as defined by an administrator.

The client device 210 is also authenticated by the endpoint management server 242. As part of the authentication, a client certificate is installed on the client device 210. The client certificate allows the virtual server 220 to trust the client device 210. The endpoint management platform 240 is available as a cloud service configuration. Other suitable platforms for managing client devices 210 may be used in different embodiments.

The virtual apps and desktop platform 250 allows the client device 210 to launch a virtual computing session 230(1). One example architecture is provided by Citrix Virtual Apps and Desktops (CVAD), from Citrix Systems, Inc. CVAD is an application virtualization platform that helps optimize productivity with universal access to virtual apps and server-based desktops from different client devices 210. CVAD carries all the same functionality as Citrix Virtual Apps, plus the option to implement a scalable Virtual Desktop Infrastructure (VDI). Citrix Virtual Apps/CVAD are available as a cloud service or an on-prem configuration. Other suitable platforms for providing virtual desktops and virtual apps may be used in different embodiments.

A broker server 252 determines which virtual desktop and virtual apps a client device 210 is allowed to access, as well as determining which virtual machine 232(1) is to host the virtual computing session 230(1) to be accessed by the client device 210. The broker server 252 includes at least one processor and at least one memory cooperating therewith. In addition, the broker server 252 performs power management for the virtual machine 232(1).

Once the client device 210 knows which virtual machine 230(1) has been assigned by the broker server 252, the endpoint management server 242 is able to map the client device 210 to the same virtual machine 232(1) being accessed by the client device 210. The mapping provides a roadmap on where to send the power control signal based on selection of the physical power control input 212.

For the virtual machine 232(1) to be linked to the physical power control input 212 on the client device 210, a link between the endpoint management server 242 and the broker server 252 is provided. This link allows the broker server 252 to receive the at least one power control signal relayed from the endpoint management server 242. The broker server 252 then initiates, in response to the received at least one power control signal and the client device 210 being mapped to the virtual machine 232(1), a change in an on/off state of the virtual machine 232(1) to match a change in the on/off state of the client device 210 so as to reboot the virtual machine 232(1).

The broker server 252 notifies the endpoint management server 242 when the virtual machine 232(1) changes on/off states to ensure that the client device 210 and the virtual machine 232(1) are in synch and have the same on/off state. When the user of the client device 210 selects the physical power control input 212 to change the client device 210 from an on-state to an off-state and then back to an on-state to initiate a reboot, the same function is being performed on the virtual machine 232(1) being accessed by the client devoice 210.

With the endpoint management server 242 connecting with the broker server 252 to relay the power control input signal from the client device 210, the client device 210 is now linked to the virtual machine 232(1). When the user of the client device 210 selects the physical power control input 212 on the client device 210 to initiate a reboot, a reboot of the virtual machine 232(1) is also performed.

Power management control from the broker server 252 to the virtual server 220 will now be discussed. The virtual server 220 providing the virtual computing sessions 230(1)-230(N) may be in a data center 215. Depending on the size of the data center 215, there may be a single virtual server 220 or a combination of virtual servers 220 interconnected as a server grid. There are several cloud service providers that organizations may turn to in order to provide desktop virtualization systems for their users. Example cloud service providers include Microsoft Azure and Amazon Web Services.

The virtual server 220 includes a plurality of virtual machines 232(1)-232(N) providing the plurality of virtual computing sessions 230(1)-230(N). A plurality of virtual delivery agents 234(1)-234(N) are associated with the plurality of virtual machines 232(1)-232(N). The virtual delivery agents 234(1)-234(N) may be generally referred to as virtual delivery agents 234. Each client device 210 will have a virtual machine 232 and a corresponding virtual delivery agent 234 assigned by the broker server 252.

A virtual delivery agent 232 is software installed on a virtual machine 232 running in the virtual server 220. The virtual machine 232 provides the virtual computing session 230, and the virtual delivery agent 234 makes the virtual computing session 230 remotely available to a client device 210. The virtual delivery agent 234 may be a Citrix Virtual Delivery Agent (VDA), for example.

The virtual server 220 includes at least one hypervisor 236 to create and run the virtual machines 232. The hypervisor may also be referred to as a virtual machine monitor (VMM). When the virtual server 220 receives the power management control from the broker server 252, it is received by the hypervisor 236. The hypervisor 236 has the function of instructing the particular virtual machine 232 providing the virtual computing session 230 being accessed by the client device 210 to change on/off states. The broker server 252 thus instructs the hypervisor 236 on which virtual machine 234 to reboot.

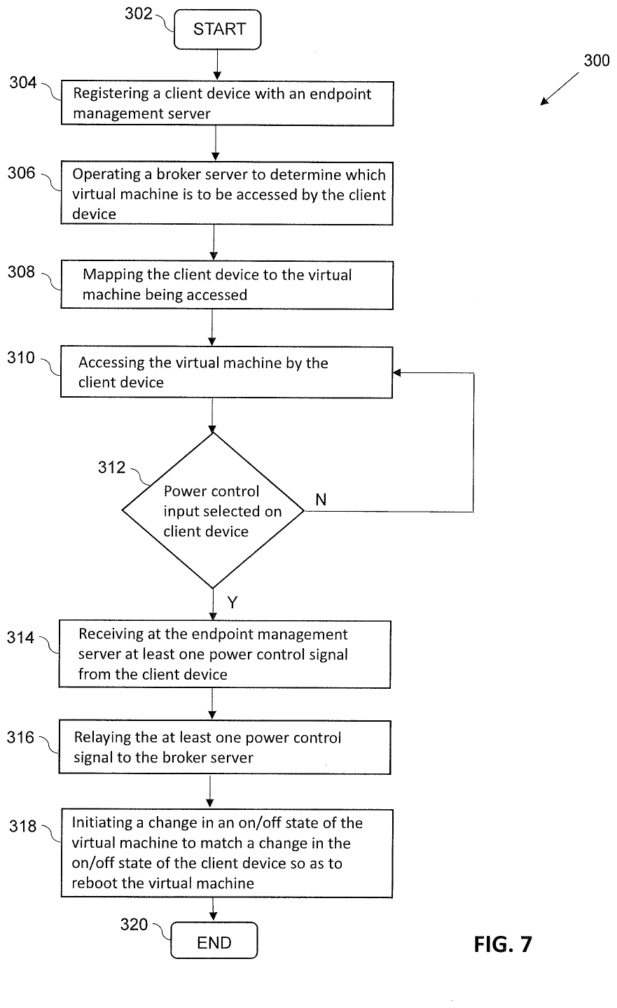

Referring now to FIG. 7, a flowchart 300 illustrating a method for operating the computer system 200 will be discussed. From the start (Block 302), the method includes registering a client device 210 with an endpoint management server 242 at Block 304. A broker server 252 is operated to determine which virtual machine 232(1) is to be accessed by the client device 210 at Block 306. The endpoint management server 242 maps the client device 210 to the virtual machine 232(1) at Block 308.

The client device 210 accesses the virtual machine 232(1) at Block 310. A determination is made at decision Block 312 on if the physical power control input 212 on the client device 210 has been selected by the user. If the physical power control input 212 has not been selected, then the method loops back to Block 310 with the client device 210 continuing to access the virtual machine 232(1).

If the physical power control input 212 has been selected by the user, then the endpoint management server 242 receives at least one power control signal from the client device 210 at Block 314. The endpoint management server 242 relays the at least one power control signal to the broker server 252 at Block 316. The broker server 252 initiates at Block 318, in response to the received at least one power control signal and the client device 210 being mapped to the virtual machine 232(1), a change in an on/off state of the virtual machine 232(1) to match a change in the on/off state of the client device 210 so as to reboot the virtual machine 232(1). The method ends at Block 320.

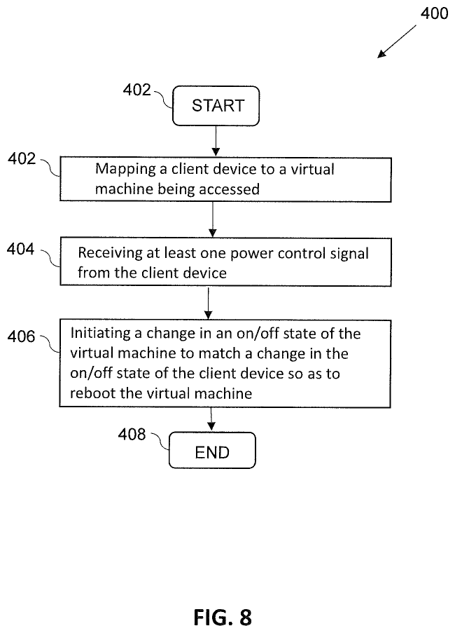

Referring now to FIG. 8, a flowchart 400 illustrating a method for operating the cloud computing service 260 or computing platform within the computer system 200 will be discussed. From the start (Block 402), the method includes the cloud computing service 260 mapping a client device 210 to a virtual machine 232(1) at Block 402. The cloud computing service 260 receives at leat one power control signal from the client device 210 at Block 404. The cloud computing service 260 initiates at Block 406, in response to the received at least one power control signal and the client device 210 being mapped to the virtual machine 232(1), a change in an on/off state of the virtual machine 232(1) to match a change in the on/off state of the client device 210 so as to reboot the virtual machine 232(1). The method ends at Block 408.

As will be appreciated by one of skill in the art upon reading the above disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

That which is claimed:

1. A computer system comprising:
a client device including a physical power control input to change said client device between on/off states;
a virtual server configured to run a plurality of virtual machines, with said client device accessing one of the virtual machines; and
a computing platform interfacing with said client device and said virtual server and configured to
map said client device to the virtual machine being accessed by said client device,
receive at least one power control signal from said client device based on selection of the physical power control input, and
initiate, in response to the received at least one power control signal and said client device being mapped to the virtual machine, a change in an on/off state of the virtual machine to match a change in the on/off state of said client device so as to reboot the virtual machine.

2. The computer system according to claim 1 wherein the received at least one power control signal includes first and second power control signals, and wherein the virtual machine changes from an on-state to an off-state based on the first power control signal, and back to the on-state based on the second power control signal so that the virtual machine reboots along with said client device.

3. The computer system according to claim 1 wherein the physical power control input comprises a push button, with the push button being pressed for a set duration so that the at least one power control signal is a single power control signal, and wherein the virtual machine changes from an on-state to an off-state and back to the on-state based on the single power control signal so that the virtual machine reboots along with said client device.

4. The computer system according to claim 1 wherein said computing platform notifies said client device when the virtual machine changes on/off states to ensure that said client device and the virtual machine have the same on/off state.

5. The computer system according to claim 1 wherein said computing platform comprises:
an endpoint management server configured to register said client device before performing the mapping, and receive the at least one power control signal from said client device; and
a broker server configured to receive the at least one power control signal from said endpoint management server, and initiate the change in the on/off state of the virtual machine.

6. The computer system according to claim 1 wherein the plurality of virtual machines provide a plurality of virtual computing sessions, with said client device accessing one of the virtual computing sessions; and wherein said virtual server further comprises at least one hypervisor configured to manage the plurality of virtual machines, and to change the on/off state of the virtual machine providing the virtual computing session to said client device in response to the received at least one power control signal and said client device being mapped to the virtual machine.

7. The computer system according to claim 1 wherein said computing platform is cloud-based.

8. The computer system according to claim 1 wherein said client device is configured as a thin client device.

9. A computing platform comprising:
at least one memory and at least one processor cooperating with said at least one memory, and configured to
map a client device to a virtual machine being accessed by the client device, and with the client device including a physical power control input to change the client device between on/off states,
receive at least one power control signal from the client device based on selection of the physical power control input, and
initiate, in response to the received at least one power control signal and the client device being mapped to the virtual machine, a change in an on/off state of the virtual machine to match a change in the on/off state of the client device so as to reboot the virtual machine.

10. The computing platform according to claim 9 wherein the received at least one power control signal includes first and second power control signals, and wherein the virtual machine changes from an on-state to an off-state based on the first power control signal, and back to the on-state based on the second power control signal so that the virtual machine reboots along with the client device.

11. The computing platform according to claim 9 wherein the physical power control input comprises a push button, with the push button being pressed for a set duration so that the at least one power control signal is a single power control signal, and wherein the virtual machine changes from an on-state to an off-state and back to the on-state based on the single power control signal so that the virtual machine reboots along with the client device.

12. The computing platform according to claim 9 wherein said at least one processor notifies the client device when the virtual machine changes on/off states to ensure that the client device and the virtual machine have the same on/off state.

13. The computing platform according to claim 9 wherein said at least one processor comprises first and second processors, and said at least one memory comprises first and second memories;
said first processor and said first memory configured to form an endpoint management server to register the client device before performing the mapping, and receive the at least one power control signal from the client device; and
said second processor and said second memory configured to form a broker server to receive the at least one power control signal from the endpoint management server, and initiate the change in the on/off state of the virtual machine.

14. The computing platform according to claim 9 wherein said at least one memory and said at least one processor are cloud-based.

15. The computing platform according to claim 9 wherein the client device is configured as a thin client device.

16. A method comprising:
mapping a client device to a virtual machine being accessed by the client device, and with the client device including a physical power control input to change the client device between on/off states;
receiving at least one power control signal from the client device based on selection of the physical power control input; and
initiating, in response to the received at least one power control signal and the client device being mapped to the virtual machine, a change in an on/off state of the virtual machine to match a change in the on/off state of the client device so as to reboot the virtual machine.

17. The method according to claim 16 wherein the received at least one power control signal includes first and second power control signals, and wherein the virtual machine changes from an on-state to an off-state based on the first power control signal, and back to the on-state based on the second power control signal so that the virtual machine reboots along with the client device.

18. The method according to claim 16 wherein the physical power control input comprises a push button, with the push button being pressed for a set duration so that the at least one power control signal is a single power control signal, and wherein the virtual machine changes from an on-state to an off-state and back to the on-state based on the single power control signal so that the virtual machine reboots along with the client device.

19. The method according to claim 16 further comprising notifying the client device when the virtual machine changes on/off states to ensure that the client device and the virtual machine have the same on/off state.

20. The method according to claim 16 wherein the client device is configured as a thin client device.
